(19) United States
(12) Patent Application Publication
(10) Pub. No.: US 2019/0181693 A1
(43) Pub. Date: Jun. 13, 2019

(54) NON-CONTACT POWER RECEIVING DEVICE AND NON-CONTACT POWER TRANSMITTING DEVICE

(71) Applicant: TOSHIBA TEC KABUSHIKI KAISHA, Tokyo (JP)

(72) Inventor: Masakazu Kato, Numazu Shizuoka (JP)

(21) Appl. No.: 16/199,396

(22) Filed: Nov. 26, 2018

(30) Foreign Application Priority Data
Dec. 8, 2017 (JP) 2017-235692
Jun. 25, 2018 (JP) 2018-120094

(51) Int. Cl. H02J 50/60; H02J 7/02; H02J 50/12

(52) U.S. Cl. CPC H02J 50/60; H02J 50/80; H02J 50/12; H02J 7/025

(57) ABSTRACT

According to one embodiment, a non-contact power receiving device, which receives electric power wirelessly supplied from a non-contact power transmitting device, includes a power receiving coil, a load circuit, a first temperature sensor, a second temperature sensor, and a control circuit. The control circuit calculates a gradient indicating a change in a temperature difference between a temperature detected by the first temperature sensor and a temperature detected by the second temperature sensor, and outputs information for stopping power transmission to the non-contact power transmitting device when the gradient is equal to or greater than a preset threshold value.

### CROSS-REFERENCE TO RELATED APPLICATIONS

The present application is based upon and claims the benefit of priorities from Japanese Patent Application No. P2017-235692 filed on Dec. 8, 2017 and Japanese Patent Application No. P2018-120094 filed on Jun. 25, 2018, the entire contents of which are hereby incorporated by reference.

### FIELD

Embodiments of the present invention relate to a non-contact power receiving device and a non-contact power transmitting device.

### BACKGROUND

Non-contact electric power transmitting apparatuses that transmit electric power in a non-contact manner are becoming widespread. The non-contact electric power transmitting apparatus includes a non-contact power transmitting device for supplying electric power (transmitting power) and a non-contact power receiving device for receiving electric power supplied from the non-contact power transmitting device. The non-contact power transmitting device supplies the electric power to the non-contact power receiving device by using electromagnetic coupling, such as electromagnetic induction or magnetic field resonance. The non-contact power transmitting device has a power transmission table provided with a power transmission coil and supplies the electric power to the non-contact power receiving device placed on the power transmission table by generating a magnetic field from the power transmission coil. The non-contact power receiving device generally includes a secondary battery and performs charging for storing the electric power supplied from the non-contact power transmitting device with respect to the secondary battery.

In such a non-contact electric power transmitting apparatus, it is assumed that some foreign object is inserted between the power transmission table of the non-contact power transmitting device and the non-contact power receiving device. For example, when the foreign object is a conductor, such as a metal, when the electric power is supplied from the non-contact power transmitting device to the non-contact power receiving device placed on the power transmission table, an eddy-current is generated in the conductor and heat is generated. Here, there is a non-contact power transmitting device which compares a difference between the temperature in the vicinity of the coil and the temperature at a position away from the coil with a preset threshold value and detects and reports the foreign object.

When it takes time to detect the foreign object, there is a possibility that a user may be away from the non-contact power transmitting device and the user cannot recognize the existence of the foreign object. Therefore, there is a problem that it is necessary to detect the foreign object at an early stage.

### DESCRIPTION OF THE DRAWINGS

FIG. 1 is a view for describing a configuration example of a non-contact electric power transmitting apparatus according to an embodiment;

FIG. 2 is a view for describing a configuration example of a non-contact power transmitting device and a non-contact power receiving device according to a first embodiment;

FIG. 3 is an explanatory view for describing a disposition position of a temperature sensor of the non-contact power receiving device according to the first embodiment;

FIG. 4 is a view for describing an example of an operation of the non-contact power transmitting device according to the first embodiment;

FIG. 5 is a view for describing an example of an operation of the non-contact power receiving device according to the first embodiment;

FIG. 6 is a view for describing an example of the operation of the non-contact power receiving device according to the first embodiment;

FIG. 7 is an explanatory view for describing a temperature difference of a plurality of temperature sensors of the non-contact power receiving device according to the first embodiment;

FIG. 8 is an explanatory view for describing a gradient of the temperature difference of the plurality of temperature sensors of the non-contact power receiving device according to the first embodiment;

FIG. 9 is a view for describing a configuration example of a non-contact power transmitting device and a non-contact power receiving device according to a second embodiment;

FIG. 10 is an explanatory view for describing a disposition position of a temperature sensor of the non-contact power transmitting device according to the second embodiment;

FIG. 11 is a view for describing an example of an operation of the non-contact power transmitting device according to the second embodiment;

FIG. 12 is a view for describing an example of an operation of a non-contact power transmitting device according to a third embodiment;

FIG. 13 is an explanatory view for describing a temperature difference of a plurality of temperature sensors of the non-contact power transmitting device according to the third embodiment;

FIG. 14 is an explanatory view for describing a gradient of a temperature difference of the plurality of temperature sensors of the non-contact power transmitting device according to the third embodiment; and

FIG. 15 is a view for describing another configuration example of the non-contact power transmitting device and the non-contact power receiving device according to the second embodiment.

### DETAILED DESCRIPTION

An exemplary embodiment provides a non-contact power receiving device and a non-contact power transmitting device which are capable of detecting foreign object at an early stage.

In general, according to one embodiment, a non-contact power receiving device, which receives electric power wirelessly supplied from a non-contact power transmitting device, includes a power receiving coil, a load circuit, a first temperature sensor, a second temperature sensor, and a control circuit. The control circuit calculates a gradient indicating a change in a temperature difference between a temperature detected by a first temperature sensor and a temperature detected by a second temperature sensor, and outputs information for stopping power transmission to the non-contact power transmitting device when the gradient is equal to or greater than a preset threshold value.

Hereinafter, a non-contact power transmitting device, a non-contact power receiving device, and a non-contact electric power transmitting apparatus according to an embodiment will be described with reference to the drawings.

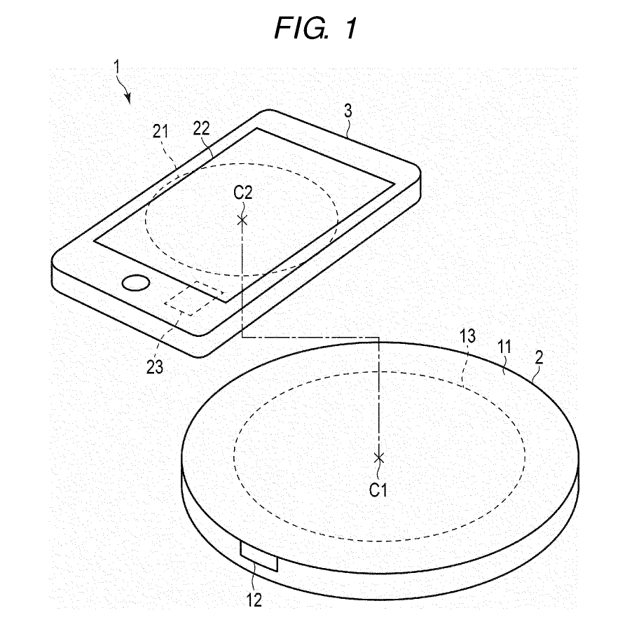

FIG. 1 is an explanatory view illustrating a configuration example of a non-contact electric power transmitting apparatus 1 according to the embodiment.

The non-contact electric power transmitting apparatus 1 includes a non-contact power transmitting device 2 for supplying electric power (transmitting power) and a non-contact power receiving device 3 for receiving electric power supplied from the non-contact power transmitting device 2.

The non-contact power transmitting device 2 supplies the electric power to the non-contact power receiving device 3 by using magnetic coupling, such as electromagnetic induction or magnetic field resonance. In other words, the non-contact power transmitting device 2 supplies the electric power to the non-contact power receiving device 3 in a state not electrically connected to the non-contact power receiving device 3. As illustrated in FIG. 1, the non-contact power transmitting device 2 includes a power transmission table 11, a display unit 12, and a power transmission coil 13.

The power transmission table 11 is a part in which a part of a housing of the non-contact power transmitting device 2 is formed in a flat plate shape, and the power transmission coil 13 is provided on the inside of the housing.

The display unit 12 is an indicator (for example, an LED or a display) indicating a state of the non-contact power transmitting device 2.

The power transmission coil 13 is connected to a power transmission circuit that generates a magnetic field by AC power. The power transmission coil 13 is configured to be disposed in parallel with a surface (placement surface) on which the non-contact power receiving device 3 of the power transmission table 11 is placed.

The non-contact power receiving device 3 is a device that receives the electric power transmitted from the non-contact power transmitting device 2. The non-contact power receiving device 3 is configured as a portable information terminal, such as a smartphone or a tablet PC. In addition, the non-contact power receiving device 3 may be configured to be connected to a power source terminal of the portable information terminal, such as a smartphone or a tablet PC, and to supply the electric power transmitted from the non-contact power transmitting device 2 to the portable information terminal. In addition, as illustrated in FIG. 1, the non-contact power receiving device 3 includes a power receiving coil 21, a display unit 22, and a secondary battery 23.

The power receiving coil 21 is an element that generates a current based on a change in the magnetic field, and is configured to be disposed in parallel with any surface of the housing of the non-contact power receiving device 3. The power receiving coil 21 may be configured as a winding structure in which an insulated wire is wound or may be configured such that a coil pattern is formed on a printed board. In a state where a surface on which the power receiving coil 21 of the housing of the non-contact power receiving device 3 is provided is oriented toward the placement surface of the power transmission table 11, when the non-contact power receiving device 3 is placed on the power transmission table 11, the power receiving coil 21 is electromagnetically coupled to the power transmission coil 13 of the non-contact power transmitting device 2.

The secondary battery 23 is a battery that is charged with electric power generated in the power receiving coil 21 and supplies the electric power to each part of the non-contact power receiving device 3.

The display unit 22 is a display device for displaying various pieces of information.

The non-contact power transmitting device 2 generates the magnetic field from the power transmission coil 13 by supplying the AC power (transmission power) to the power transmission coil 13. The non-contact power transmitting device 2 supplies the electric power to the non-contact power receiving device 3 via the power receiving coil 21 electromagnetically coupled to the power transmission coil 13 by generating the magnetic field from the power transmission coil 13.

The power receiving coil 21 of the non-contact power receiving device 3 generates an induced current by the magnetic field output from the power transmission coil 13 of the non-contact power transmitting device 2. The non-contact power receiving device 3 performs charging for storing the electric power generated in the power receiving coil 21 in the secondary battery 23.

In addition, the efficiency of the power transmission between the non-contact power transmitting device 2 and the non-contact power receiving device 3 deteriorates in accordance with the magnitude of shift (positional shift) of the center C1 of the power transmission coil 13 and the center C2 of the power receiving coil 21. Further, there is a case where foreign object is inserted between the non-contact power transmitting device 2 and the non-contact power receiving device 3. When the foreign object is a conductor, such as a metal, for example, the electric power transmitted from the non-contact power transmitting device 2 is absorbed by the foreign object, and thus, the foreign object generates heat and at the same time the efficiency of the power transmission deteriorates.

### First Embodiment

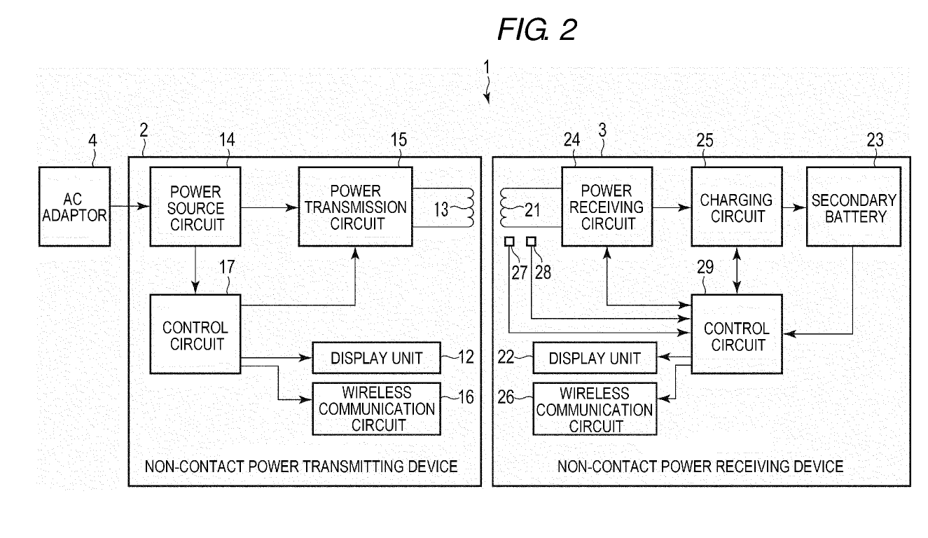

FIG. 2 is an explanatory view for describing a configuration example of the non-contact power transmitting device 2 and the non-contact power receiving device 3 of the non-contact electric power transmitting apparatus 1 according to the first embodiment.

First, the non-contact power transmitting device 2 will be described.

DC power is supplied to the non-contact power transmitting device 2 from a commercial power source via a DC power source, such as an AC adapter 4. The non-contact power transmitting device 2 is operated by the DC power source in either a power transmission state of supplying the electric power to the non-contact power receiving device 3 or a standby state of not supplying the electric power to the non-contact power receiving device 3.

The non-contact power transmitting device 2 includes a power source circuit 14, a power transmission circuit 15, a power transmission coil 13, a display unit 12, a wireless communication circuit 16, a control circuit 17, and the like. The power source circuit 14 converts a voltage of an external DC power source into a voltage appropriate for the operation of each circuit. Accordingly, the power source circuit 14 generates the electric power for causing the power transmission circuit 15 to perform the power transmission, and supplies the electric power to the power transmission circuit 15. In addition, the power source circuit 14 generates the electric power for operating the control circuit 17, and supplies the electric power to the control circuit 17.

Under the control of the control circuit 17, the power transmission circuit 15 generates the AC power (transmission power) by switching the DC power supplied from the power source circuit 14. The power transmission circuit 15 generates the magnetic field in the power transmission coil 13 by supplying the AC power to the power transmission coil 13.

As the power transmission coil 13 is connected to a capacitor for resonance (not illustrated) in series or in parallel, a resonance circuit may be configured. The power transmission coil 13 generates the magnetic field by the electric power supplied from the power transmission circuit 15.

The display unit 12 is an indicator illustrating the state of the non-contact power transmitting device 2. The display unit 12 switches the display according to the control of the control circuit 17. For example, the display unit 12 switches the display color according to the operation state of the non-contact power transmitting device 2. Further, for example, the display unit 12 may switch the display color according to the result of the foreign object detecting. Otherwise, the display unit 12 may display the operation state as a message.

The wireless communication circuit 16 is an interface for performing wireless communication with the non-contact power receiving device 3. The wireless communication circuit 16 is a circuit that performs the wireless communication at a frequency different from the frequency of the power transmission. The wireless communication circuit 16 is, for example, a wireless LAN using a 2.4 GHz or 5 GHz band, a near field wireless communication device using a 920 MHz band, a communication device using infrared, or the like. Specifically, the wireless communication circuit 16 is a circuit that performs the wireless communication with the non-contact power receiving device 3 according to standards, such as Bluetooth (registered trademark) or Wi-Fi (registered trademark). In addition, the wireless communication circuit 16 may be a circuit that performs signaling for load-modulating a carrier wave of the power transmission and performing communication with the non-contact power receiving device 3.

The control circuit 17 controls the operations of the power transmission circuit 15, the display unit 12, and the wireless communication circuit 16, respectively. The control circuit 17 includes a processor and a memory. The processor executes arithmetic processing. The processor performs various processes based on, for example, a program stored in the memory and data used in the program. The memory stores the program and the data used in the program. In addition, the control circuit 17 may be configured of a microcomputer and/or an oscillation circuit or the like.

For example, the control circuit 17 switches the display of the display unit 12 in accordance with the state of the non-contact power transmitting device 2. In addition, for example, the control circuit 17 controls the communication with the non-contact power receiving device 3 via the wireless communication circuit 16.

Further, for example, the control circuit 17 controls the frequency of the AC power output from the power transmission circuit 15 and controls ON and OFF of the operation of the power transmission circuit 15. For example, by controlling the power transmission circuit 15, the control circuit 17 switches the state (power transmission state) of generating the magnetic field in the power transmission coil 13 and the state (standby state) of not generating the magnetic field in the power transmission coil 13. Further, the control circuit 17 may perform a control for detecting the state where the non-contact power receiving device 3 is placed on the non-contact power transmitting device 2 by intermittently generating the magnetic field in the power transmission coil 13, or may perform a control by generating the magnetic field smaller than that of the general power transmission state.

When an electromagnetic induction method is used for the power transmission, the control circuit 17 controls the power transmission circuit 15 so as to supply the AC power of approximately 100 kHz to 200 kHz to the power transmission coil 13. Further, when a magnetic field resonance method is used for the power transmission, the control circuit 17 supplies the AC power having a MHz band, such as 6.78 MHz or 13.56 MHz, to the power transmission coil 13. In addition, the frequency of the AC power supplied from the power transmission circuit 15 to the power transmission coil 13 is not limited to the description above, and may be changed in accordance with the specification of the non-contact power receiving device 3.

Next, the non-contact power receiving device 3 will be described.

The non-contact power receiving device 3 includes a power receiving coil 21, a power receiving circuit 24, a charging circuit 25, a secondary battery 23, a display unit 22, a wireless communication circuit 26, a first temperature sensor 27, a second temperature sensor 28, and a control circuit 29. In addition, the non-contact power receiving device 3 may be configured to include an output terminal for supplying the electric power to the load instead of the charging circuit 25 and the secondary battery 23.

As the power receiving coil 21 is connected to the capacitor (not illustrated) in series or in parallel, the resonance circuit may be configured. When the non-contact power receiving device 3 is placed on the power transmission table 11 of the non-contact power transmitting device 2, the power receiving coil 21 is electromagnetically coupled to the power transmission coil 13 of the non-contact power transmitting device 2. The power receiving coil 21 generates the induced current by the magnetic field output from the power transmission coil 13 of the non-contact power transmitting device 2. In other words, the power receiving resonance circuit configured with the power receiving coil 21 and the capacitor (not illustrated) functions as the AC power source for supplying the AC power (received power) to the power receiving circuit 24 connected to the power receiving resonance circuit.

For example, when using the magnetic field resonance method for the power transmission, a configuration in which a self-resonance frequency of the power receiving resonance circuit is the same as or substantially the same as the frequency of the power transmission of the non-contact power transmitting device 2 is desirable. Accordingly, the power transmission efficiency when the power receiving coil 21 and the power transmission coil 13 are electromagnetically coupled to each other.

The power receiving circuit 24 rectifies the received power supplied from the power receiving resonance circuit and converts the received power into a direct current. The power receiving circuit 24 includes, for example, a rectifying bridge configured with a plurality of diodes. A pair of input terminals of the rectifying bridge is connected to the power receiving resonance circuit. The power receiving circuit 24 outputs the DC power from the pair of output terminals by full-wave rectifying the received power supplied from the power receiving resonance circuit. The charging circuit 25 is connected to the pair of output terminals of the power receiving circuit 24. The power receiving circuit 24 supplies the DC power to the charging circuit 25.

The charging circuit 25 converts the DC power supplied from the power receiving circuit 24 into the DC power (charging power) used for the charging. In other words, the charging circuit 25 outputs the charging power for charging the secondary battery 23 with the received power output from the power receiving circuit 24. For example, when charging the secondary battery 23, the charging circuit 25 supplies the power having a predetermined current value or a voltage value to the secondary battery 23.

The secondary battery 23 is charged with the charging power generated by the charging circuit 25 and is used for various configuration operations of the non-contact power receiving device 3.

For example, the secondary battery 23 supplies the electric power to the control circuit 29 that executes various processes of the non-contact power receiving device 3. Further, the secondary battery 23 is connected with the display unit 22, the wireless communication circuit 26, a camera (not illustrated), a speaker, and the like.

The display unit 22 is a display device for displaying various pieces of information. The display unit 22 displays a screen under the control of the control circuit 29 or a graphic controller (not illustrated).

The wireless communication circuit 26 is an interface for performing the wireless communication with the non-contact power transmitting device 2. The wireless communication circuit 26 is a circuit that performs the wireless communication at a frequency different from the frequency of the power transmission. The wireless communication circuit 26 is, for example, a wireless LAN using a 2.4 GHz or 5 GHz band, a near field wireless communication device using a 920 MHz band, a communication device using infrared, or the like. Specifically, the wireless communication circuit 26 is a circuit that performs the wireless communication with the non-contact power transmitting device 2 according to standards, such as Bluetooth (registered trademark) or Wi-Fi (registered trademark). In addition, the wireless communication circuit 26 may be a circuit that performs signaling for load-modulating a carrier wave of the power transmission and performing communication with the non-contact power transmitting device 2.

The first temperature sensor 27 and the second temperature sensor 28 are sensors for detecting the temperature, respectively. The first temperature sensor 27 and the second temperature sensor 28 respectively supply detection signals indicating the detected temperatures to the control circuit 29.

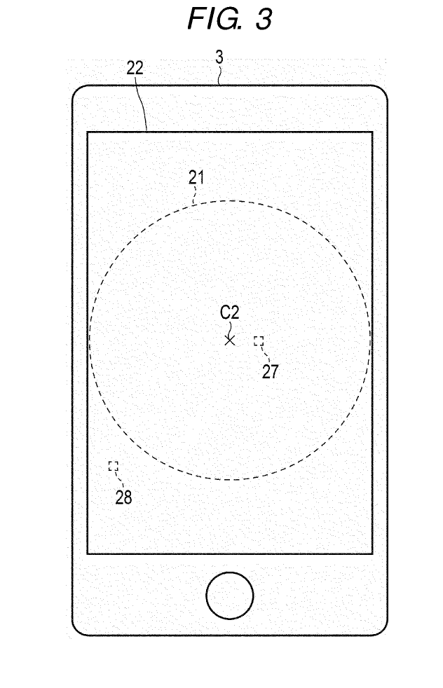

FIG. 3 is an explanatory view for describing an example of an installation position of the first temperature sensor 27 and the second temperature sensor 28. As illustrated in FIG. 3, the first temperature sensor 27 detects the temperature in the vicinity of the center C2 of the power receiving coil 21. The vicinity of the center C2 is a position where the magnetic field received by the power receiving coil 21 is strong (magnetic flux density is high). As the first temperature sensor 27 is configured to detect the temperature at a position where the magnetic flux density is high in this manner, it becomes easy to detect a change in temperature due to the foreign object.

Further, the second temperature sensor 28 detects the temperature at a position away from the center C2 of the power receiving coil 21, for example, the temperature at a position further on the outside than the power receiving coil 21. The position away from the center C2 is a position where the magnetic field received by the power receiving coil 21 is weak (magnetic flux density is low) or where it is unlikely to be influenced by the magnetic field. As the second temperature sensor 28 is configured to detect the temperature at a position where the magnetic flux density is low in this manner, it becomes difficult to detect the change in temperature due to the foreign object compared to the first temperature sensor 27.

As described above, the first temperature sensor 27 is disposed at a position close to the center C2 of the power receiving coil 21, and the second temperature sensor 28 is disposed at a position far from the center C2 of the power receiving coil 21. In other words, the first temperature sensor 27 detects the temperature at a position closer to the center C2 of the power receiving coil 21 than the second temperature sensor 28. As the positions for detecting the temperatures of the first temperature sensor 27 and the second temperature sensor 28 is set in this manner, a difference between the detection results of the change in temperature due to the foreign object by the first temperature sensor 27 and the second temperature sensor 28 arises.

The control circuit 29 controls operations of the power receiving circuit 24, the charging circuit 25, the display unit 22, and the wireless communication circuit 16, respectively. The control circuit 29 includes a processor and a memory. The processor executes arithmetic processing. The processor performs various processes based on, for example, a program stored in the memory and data used in the program. The memory stores the program and the data used in the program.

For example, the control circuit 29 causes the display unit 22 to display various pieces of information. In addition, for example, the control circuit 29 controls the communication with the non-contact power transmitting device 2 via the wireless communication circuit 26.

The control circuit 29 controls the operation of the charging circuit 25. For example, as the control circuit 29 controls the charging circuit 25, a state of charging the secondary battery 23 (performing the charging) and a state where the charging is not performed are switched to each other.

Next, the operation of the non-contact power transmitting device 2 having the above-described configuration will be described.

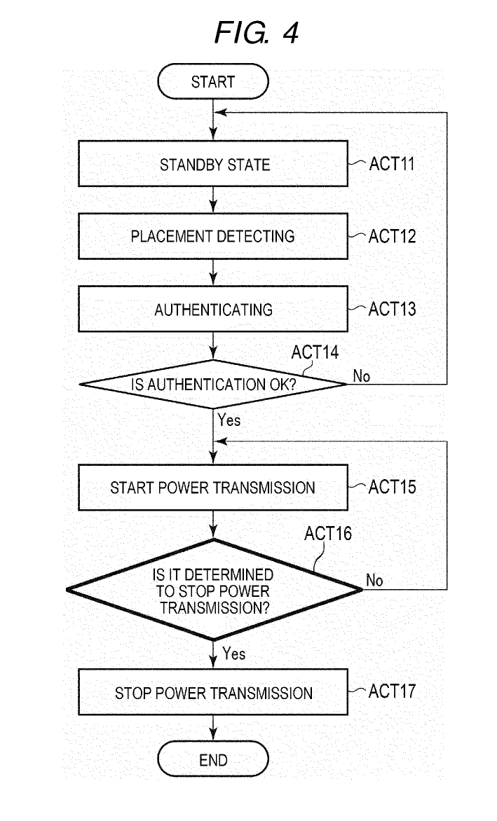

FIG. 4 is a flowchart for describing an example of the operation of the non-contact power transmitting device 2. When being activated, the non-contact power transmitting device 2 operates in a standby state (ACT 11). At this time, the control circuit 17 performs a control such that the power transmission circuit 15 operates at regular time intervals. Accordingly, the power transmission circuit 15 intermittently supplies the transmission power to the power transmission coil 13.

The control circuit 17 performs placement detecting while intermittently performing the power transmission (ACT 12). The placement detecting is a process for determining whether or not the non-contact power receiving device 3 to which the electric power is supplied is placed on the power transmission table 11. The control circuit 17 of the non-contact power transmitting device 2 determines whether or not the non-contact power receiving device 3 to which the electric power is supplied is placed on the power transmission table 11 based on the detection result of a current detection circuit (not illustrated) that detects the current supplied from the power transmission circuit 15 to the power transmission coil 13. Otherwise, the control circuit 17 determines whether or not the non-contact power receiving device 3 to which the electric power is supplied is placed on the power transmission table 11 based on the detection result of a current detection circuit (not illustrated) that detects the current supplied from the power source circuit 14 to the power transmission circuit 15.

For example, in the standby state, the control circuit 17 intermittently supplies the transmission power from the power transmission circuit 15 to the power transmission coil 13. When the detection result of the current detection circuit increases while the transmission power is being supplied from the power transmission circuit 15 to the power transmission coil 13, the control circuit 17 determines that the non-contact power receiving device 3 is placed on the power transmission table 11.

When it is determined that the non-contact power receiving device 3 is placed on the power transmission table 11, the control circuit 17 performs authenticating (ACT 13). The authenticating is a process for determining whether or not a counterpart device that performs the power transmission is a correct device between the non-contact power transmitting device 2 and the non-contact power receiving device 3. The non-contact power transmitting device 2 and the non-contact power receiving device 3 perform the authenticating by transmitting and receiving predetermined information to and from each other.

For example, the authenticating is a process in which the non-contact power transmitting device 2 determines whether or not the non-contact power receiving device 3 placed on the power transmission table 11 is a correct device. For example, the control circuit 17 of the non-contact power transmitting device 2 acquires authentication information from the non-contact power receiving device 3 via the wireless communication circuit 16. The authentication information is information indicating identification information of the non-contact power receiving device 3, model number, corresponding power transmission method, corresponding frequency, and the like. By comparing the acquired authentication information with the information recorded in the memory, the control circuit 17 determines that the non-contact power receiving device 3 placed on the power transmission table 11 is a correct device that can supply the electric power by the non-contact power transmitting device 2. The authentication information may be only the identification information of the non-contact power transmitting device 2 or the non-contact power receiving device 3, or may be other information.

In addition, the authenticating may be a process in which the non-contact power receiving device 3 determines whether or not the non-contact power transmitting device 2 having the power transmission table 11 on which the non-contact power receiving device 3 is placed is a correct device. In this case, the control circuit 29 of the non-contact power receiving device 3 acquires authentication information from the non-contact power transmitting device 2 via the wireless communication circuit 26. The authentication information is information indicating the identification information of the non-contact power transmitting device 2, model number, corresponding power transmission method, corresponding frequency, and the like. By comparing the acquired authentication information with the information recorded in the memory, the control circuit 29 determines whether or not the non-contact power transmitting device 2 is a correct device that corresponds to the control circuit 29.

The control circuit 17 determines whether or not the result of the authenticating is normal (ACT 14). When it is determined that the authenticating is not performed normally (the authentication result is NG) (ACT 14, NO), the control circuit 17 moves to the process of ACT 11.

When it is determined that the authenticating is performed normally (ACT 14, YES), the control circuit 17 starts the power transmission to the non-contact power receiving device 3 by supplying the transmission power from the power transmission circuit 15 to the power transmission coil 13 (ACT 15).

The control circuit 17 determines whether to stop the power transmission to the non-contact power receiving device 3 (ACT 16). For example, the control circuit 17 sequentially determines whether or not the non-contact power receiving device 3 has been removed from the power transmission table 11 during the power transmission, based on the value of the current supplied from the power transmission circuit 15 to the power transmission coil 13. When it is determined that the non-contact power receiving device 3 has been removed from the power transmission table 11, the control circuit 17 determines to stop the power transmission. In addition, when information for instructing to stop the power transmission is supplied from the non-contact power receiving device 3, the control circuit 17 determines to stop the power transmission.

When it is determined not to stop the power transmission to the non-contact power receiving device 3 (ACT 16, NO), the control circuit 17 moves to the process of ACT 15 and continues the power transmission.

In addition, when it is determined to stop the power transmission to the non-contact power receiving device 3 (ACT 16, YES), the control circuit 17 stops the power transmission to the non-contact power receiving device 3 (ACT 17) and ends the process.

In addition, when information for instructing to restart the power transmission is supplied from the non-contact power receiving device 3 after the power transmission is stopped, the control circuit 17 operates the power transmission circuit 15 and restarts the power transmission.

Next, the operation of the non-contact power receiving device 3 having the above-described configuration will be described.

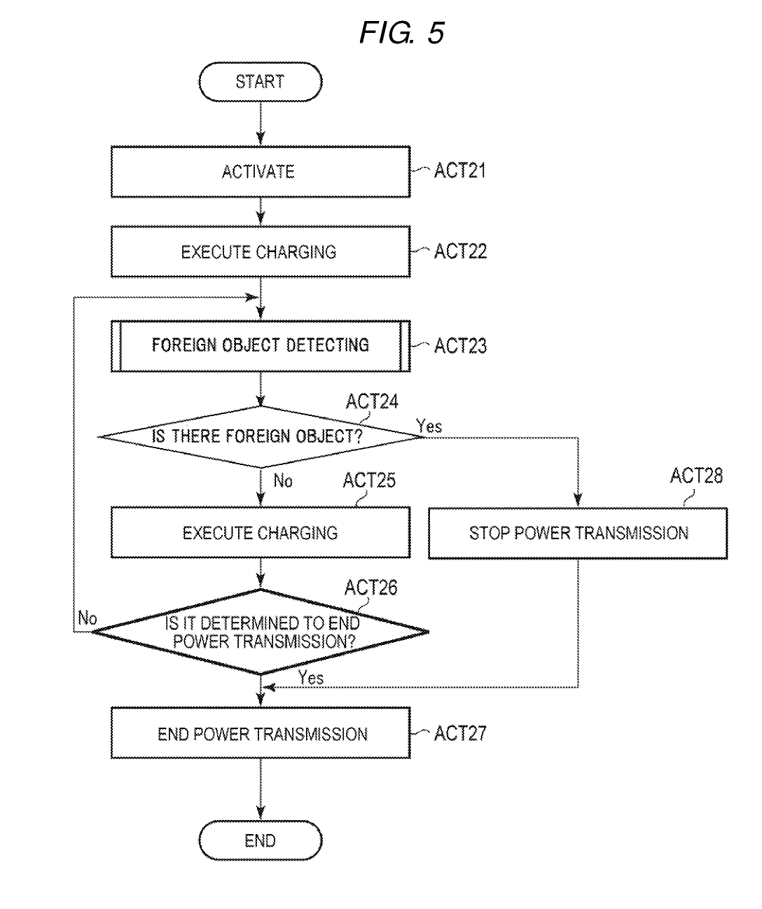

FIG. 5 is a flowchart for describing an example of the operation of the non-contact power receiving device 3.

When being placed on the power transmission table 11 of the non-contact power transmitting device 2, the non-contact power receiving device 3 is activated by the electric power supplied from the non-contact power transmitting device 2 (ACT 21).

When being activated, the control circuit 29 of the non-contact power receiving device 3 executes the charging for converting the DC power supplied from the power receiving circuit 24 to the charging circuit 25 into the charging power used for the charging, and supplying the charging power to the secondary battery 23 (ACT 22).

In addition, the control circuit 29 acquires each detected value from the first temperature sensor 27 and the second temperature sensor 28, performs foreign object detecting based on the acquired detected value (ACT 23), and determines the presence or absence of the foreign object (ACT 24). The foreign object detecting is a process for determining whether or not the foreign object is inserted between the non-contact power receiving device 3 and the non-contact power transmitting device 2. The foreign object detecting will be described later.

When it is determined that there is no foreign object in the foreign object detecting (ACT 24, NO), the control circuit 29 executes the charging for supplying the charging power to the secondary battery 23 (ACT 25). In other words, the control circuit 29 continues the charging for charging the secondary battery 23.

The control circuit 29 determines whether to end the charging (ACT 26). For example, the control circuit 29 monitors the charging state of the secondary battery 23 and determines whether or not the secondary battery 23 has been sufficiently charged. When it is determined that the secondary battery 23 has been sufficiently charged, the control circuit 29 determines to end the charging.

When it is determined not to end the charging (ACT 26, NO), the control circuit 29 moves to the process of ACT 23 and performs the foreign object detecting again. When the foreign object is not detected, the charging is continued.

In addition, when it is determined to end the charging (ACT 26, YES), the control circuit 29 ends the charging (ACT 27) and ends the process of FIG. 5.

Further, when it is determined that there is the foreign object in the ACT 24 (ACT 24, YES), the control circuit 29 transmits information for instructing to stop the power transmission or information that the foreign object is detected (ACT 28) to the non-contact power transmitting device 2 via the wireless communication circuit 26, moves to the process of ACT 27, and ends the charging. When the information for instructing to stop the power transmission performed in ACT 28 is received, the non-contact power transmitting device 2 stops the power transmission. Here, when the power source supply for the operation of the control circuit 29 is stopped immediately before moving to the process of the ACT 27, the control circuit 29 stops the operation without performing the process of the ACT 27.

Accordingly, the non-contact power transmitting device 2 is switched from the power transmission state of supplying the electric power to the non-contact power receiving device 3 to the standby state of not supplying the electric power to the non-contact power receiving device 3. In addition, when there is a remaining amount of the secondary battery 23 and the non-contact power receiving device 3 can be operated without receiving the electric power from the non-contact power transmitting device 2, the control circuit 29 displays that the foreign object exists on display unit 22. Furthermore, the control circuit 17 of the non-contact power transmitting device 2 may display that the foreign object exists on the display unit 12 of the non-contact power transmitting device 2.

Next, the foreign object detecting performed in the non-contact power receiving device 3 will be described.

As a result of detecting the temperature of the first temperature sensor 27, the control circuit 29 of the non-contact power receiving device 3 performs the foreign object detecting for detecting the presence or absence of the foreign object based on the detection result of the temperature of the first temperature sensor 27 and the detection result of the temperature of the second temperature sensor 28. The foreign object detecting is a process for determining whether or not an foreign object having some electric conductor to which the electric power is not supplied exists between the power transmission table 11 and the non-contact power receiving device 3. The foreign object may be foreign object generated by peeling off the conductor, such as a clip, or may be foreign object generated as the conductor is accommodated in a housing of resin or the like, such as the non-contact IC card.

When the power transmission from the non-contact power transmitting device 2 to the non-contact power receiving device 3 is started, each component, such as the power transmission circuit 15, the power transmission coil 13, the power receiving coil 21, and the power receiving circuit 24 generates heat. When the foreign object does not exist between the non-contact power transmitting device 2 and the non-contact power receiving device 3, the temperature of the center C1 of the power transmission coil 13 having a high magnetic flux density and the temperature of the center C2 of the power receiving coil 21 are higher than the temperature at other positions. In particular, the temperature at the center C1 of the power transmission coil 13 is higher than the temperature around the power transmission coil 13 having a low magnetic flux density, and the temperature at the center C2 of the power receiving coil 21 is higher than the temperature around the power receiving coil 21 having a low magnetic flux density. In other words, a temperature difference arises between the position close to the center C1 of the power transmission coil 13 and the center C2 of the power receiving coil 21 and a position far from the center C1 of the power transmission coil 13 and the center C2 of the power receiving coil 21.

Furthermore, when the foreign object, such as a metal, exists between the non-contact power transmitting device 2 and the non-contact power receiving device 3, a part of the electric power output from the power transmission coil 13 is absorbed by the foreign object. The electric power absorbed by the foreign object causes the eddy-current in the foreign object. Accordingly, the heat is generated in the foreign object. For example, when the foreign object, such as a metal, exists on the power transmission table 11, it is presumed that a difference in temperature arises between the position where the foreign object exists and another position.

For the above-described reasons, the temperature difference caused by the presence or absence of the foreign substance is added to the temperature difference caused by the difference in position where the temperature is detected. In other words, when the foreign object exists between the non-contact power transmitting device 2 and the non-contact power receiving device 3, compared a case where the foreign object does not exist between the non-contact power transmitting device 2 and the non-contact power receiving device 3, the difference in temperature detected by the temperature sensors provided at different positions increases. Therefore, based on the difference between the temperatures detected by the first temperature sensor 27 and the second temperature sensor 28 which are installed at different positions, the control circuit 29 determines the presence or absence of the foreign object.

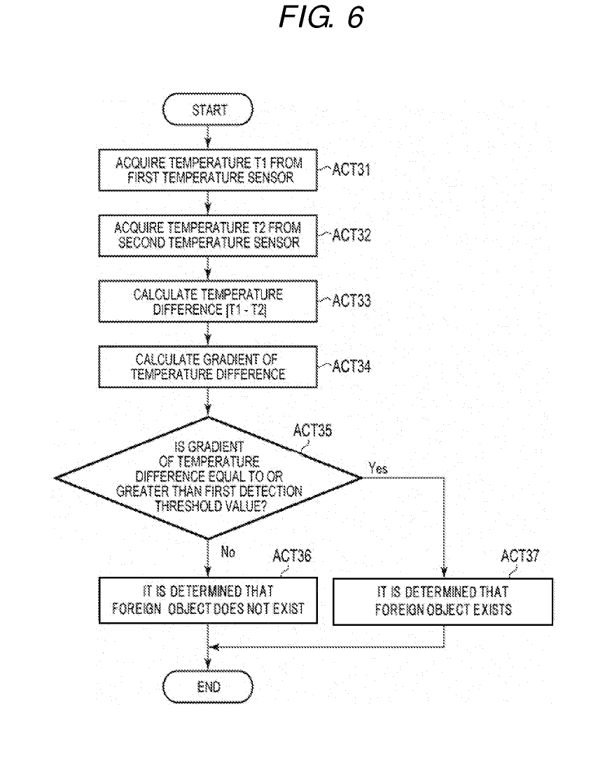

FIG. 6 is a flowchart for describing an example of the foreign object detecting in the non-contact power receiving device 3.

The control circuit 29 of the non-contact power receiving device 3 acquires a temperature T1 from the first temperature sensor 27 (ACT 31). As described above, the first temperature sensor 27 supplies a detection signal indicating the temperature in the vicinity of the center C2 of the power receiving coil 21 to the control circuit 29. The control circuit 29 A/D converts the detection signal supplied from the first temperature sensor 27 and acquires the temperature T1 which is a value indicating the temperature.

The control circuit 29 of the non-contact power receiving device 3 acquires a temperature T2 from the second temperature sensor 28 (ACT 32). As described above, the second temperature sensor 28 supplies a detection signal indicating the temperature at the position away from the center C2 of the power receiving coil 21 to the control circuit 29. The control circuit 29 A/D converts the detection signal supplied from the second temperature sensor 28 and acquires the temperature T2 which is a value indicating the temperature.

The control circuit 29 calculates a temperature difference G between the temperature T1 and the temperature T2 (ACT 33). The control circuit 29 calculates the temperature difference G by subtracting a lower value from a higher value at the temperature T1 and the temperature T2. In other words, the control circuit 29 calculates an absolute value of the temperature T1−the temperature T2 as the temperature difference G (G=|T1−T2|).

The control circuit 29 calculates a gradient S of the temperature difference based on the change of the temperature difference G according to the time (ACT 34). For example, the control circuit 29 stores the temperature difference G calculated every predetermined time in the memory. Based on the stored temperature difference G, the control circuit 29 calculates a change amount of the temperature difference G at predetermined time intervals as the gradient S of the temperature difference.

The control circuit 29 compares the gradient S of the calculated temperature difference with a preset threshold value (first detection threshold value) Th1 (ACT 35). The first detection threshold value Th1 is stored in the memory of the control circuit 29, for example. The first detection threshold value Th1 is a value which is lower than the maximum value (referred to as gradient S1) of the gradient S of the temperature difference estimated when the foreign object exists between the non-contact power transmitting device 2 and the non-contact power receiving device 3, and higher than the maximum value (referred to as gradient S2) of the gradient S of the temperature difference estimated when the foreign object does not exist between the non-contact power transmitting device 2 and the non-contact power receiving device 3.

The first detection threshold value Th1 may be stored for each type of the non-contact power transmitting device 2 that transmits the electric power. In this case, the control circuit 29 recognizes the type of the non-contact power transmitting device 2 in the above-described authenticating, reads the first detection threshold value Th1 that corresponds to the recognized type from the memory, and compares the first detection threshold value Th1 with the gradient S of the temperature difference.

Further, when the non-contact power receiving device 3 is configured to be capable of performing process, such as rapid charging with a processing load higher than that of ordinary charging, the first detecting threshold value Th1 may further be stored for each type of the charging. In this case, the control circuit 29 reads the first detection threshold value Th1 that corresponds to the type of the charging, and compares the first detection threshold value Th1 with the gradient S of the temperature difference.

When the gradient S of the calculated temperature difference is less than the first detection threshold value Th1 (ACT 35, NO), the control circuit 29 determines that the foreign object does not exist between the non-contact power transmitting device 2 and the non-contact power receiving device 3 (ACT 36) and ends the foreign object detecting. In this case, as illustrated in FIG. 5, the control circuit 29 continues the charging. In addition, it is not indispensable to determine that the foreign object by the control circuit 29 does not exist, and the charging may be continued based on the determination result of the ACT 35.

In addition, when the gradient S of the calculated temperature difference is equal to or greater than the first detection threshold value Th1 (ACT 35, YES), the control circuit 29 determines that the foreign object does not exist between the non-contact power transmitting device 2 and the non-contact power receiving device 3 (ACT 37) and ends the foreign object detecting. In this case, as illustrated in FIG. 5, the control circuit 29 stops the charging and outputs information for stopping the power transmission to the non-contact power transmitting device 2. In addition, it is not indispensable to determine that the foreign object exists by the control circuit 29, the charging may be stopped based on the determination result of ACT 35, and the information for stopping the power transmission may be output to the non-contact power transmitting device 2.

Next, a change in the temperature difference G when the foreign object detecting is performed as described above will be described.

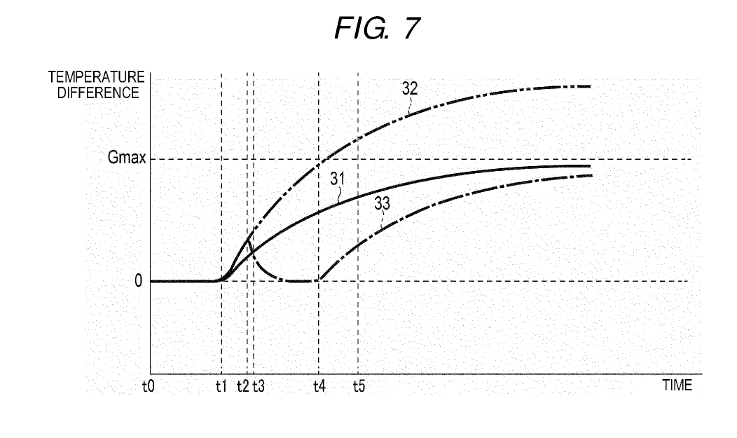

FIG. 7 is an explanatory view for describing a change in the temperature difference G after the charging is started. The vertical axis of FIG. 7 indicates the temperature difference G, and the horizontal axis indicates time.

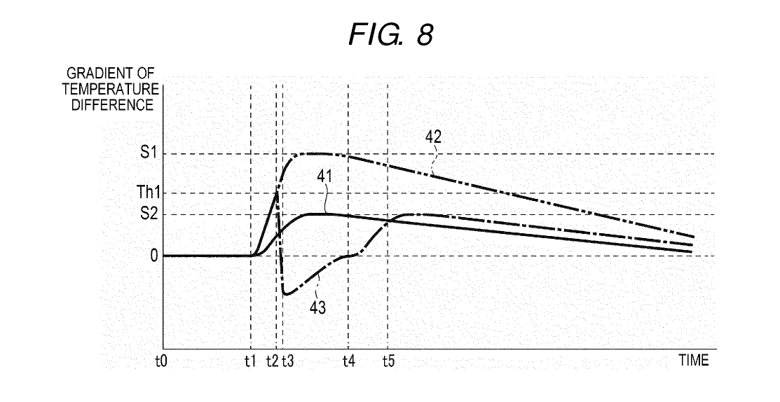

FIG. 8 is an explanatory view for describing a change in the gradient S of the temperature difference after the charging is started. The vertical axis of FIG. 8 indicates the gradient S of the temperature difference, and the horizontal axis indicates time.

In addition, it is assumed that, at timing t0, the power transmission from the non-contact power transmitting device 2 to the non-contact power receiving device 3 is not started, and at timing t1, the power transmission from the non-contact power transmitting device 2 to the non-contact power receiving device 3 is started.

A first graph 31 in FIG. 7 is a graph illustrating a change in the temperature difference G when the foreign object does not exist. The first graph 31 illustrates that the temperature difference G is 0 between timing t0 and timing t1. Further, the first graph 31 illustrates that the temperature difference G is increasing after timing t1.

A first graph 41 in FIG. 8 is a graph illustrating a change in the gradient S of the temperature difference when the foreign object does not exist. The first graph 41 illustrates that the gradient S of the temperature difference is 0 between timing t0 and timing t1. Further, the first graph 41 illustrates that the gradient S of the temperature difference increases to the gradient S2 after timing t1, and thereafter, the gradient S of the temperature difference gradually decreases. In other words, the first graph 31 and the first graph 41 illustrate that, when the foreign object does not exist, the temperature difference increases from the timing when the power transmission is started, the temperature approaches saturation as time elapses, and an increase ratio of the temperature difference decreases.

A second graph 32 of FIG. 7 is a graph illustrating the change in the temperature difference G when the foreign object, such as a metal, exists and the foreign object detecting is not performed. The second graph 32 illustrates that the temperature difference G is 0 between timing t0 and timing t1. Further, the second graph 32 illustrates that the temperature difference G is increasing after timing t1.

A second graph 42 of FIG. 8 is a graph illustrating the change in the gradient S of the temperature difference when the foreign object exists and the foreign object detecting is not performed. The second graph 42 illustrates that the gradient S of the temperature difference is 0 between timing t0 and timing t1. Further, the second graph 42 illustrates that the gradient S of the temperature difference increases to the gradient S1 after timing t1, and thereafter, the gradient S of the temperature difference gradually decreases.

The second graph 32 and the second graph 42 illustrate that, when the foreign object exists, the temperature difference sharply increases from the timing when the power transmission is started, the temperature approaches saturation as time elapses, and the increase ratio of the temperature difference decreases. In addition, the second graph 32 and the second graph 42 illustrates that the temperature difference G and the gradient S are greater than those when the foreign object does not exist.

A third graph 33 of FIG. 7 is a graph illustrating the change in the temperature difference G when the foreign object exists and the foreign object detecting is performed. The third graph 33 illustrates that the temperature difference G is 0 between timing t0 and timing t1. Further, in the third graph 33, the temperature difference G increases from timing t1 to timing t2, the temperature difference G decreases from timing t2 to timing t4, and after timing t4, the temperature difference G increases again.

A third graph 43 of FIG. 8 is a graph illustrating the change in the gradient of the temperature difference when the foreign object exists and the foreign object detecting is performed. The third graph 43 illustrates that the gradient S of the temperature difference is 0 between timing t0 and timing t1. In addition, the third graph 43 illustrates that the gradient S of the temperature difference increases from timing t1 to timing t2 and the gradient S of the temperature difference becomes equal to or higher than the first detection threshold value Th1 at timing t2. In this case, the control circuit 29 determines that the foreign object exists, and outputs the information for stopping the power transmission of the non-contact power transmitting device 2. At the same time, the operation of the charging circuit 25 is also stopped. The third graph 43 illustrates that the gradient S changes from a positive value to a negative value immediately after timing t2 at which the power transmission is stopped. In addition, the third graph 43 illustrates that the gradient S gradually returns to 0 from the negative value from timing t3 to timing t4. Furthermore, the foreign object is removed and the power transmission from the non-contact power receiving device 3 is restarted at timing t4. Therefore, the third graph 43 illustrates that the gradient S increases from timing t4 to timing t5, and the gradient S gradually decreases after timing t5.

The third graph 33 and the third graph 43 illustrate that, when the foreign object exists and the power transmission is stopped at the timing when the gradient S becomes equal to or greater than the first detection threshold value Th1, and when the temperature difference G has returned, the power transmission is restarted. Further, the third graph 33 and the third graph 43 illustrate that the foreign object is removed from the time when the power transmission is stopped until the power transmission is restarted, and the gradient S after the restart of the power transmission becomes gentle similar to that at the time when there is no foreign object.

In addition, in the above-described example, it is described that the temperature difference G in the third graph 33 returns to 0 at timing t4, but the configuration is not limited to the configuration. At timing t4 at which the power transmission is restarted, the temperature difference G may remain. The time until the temperature difference G in the third graph 33 returns to 0 changes depending on the space around each temperature sensor and the material of the structure. For example, when the time period from timing t2 to timing t4 is short (for example, several ten seconds to several minutes), the temperature difference G in the third graph 33 does not decrease to 0.

As described above, the non-contact power receiving device 3 includes the first temperature sensor 27 provided at the position close to the center C2 of the power receiving coil 21 and the second temperature sensor 28 provided at the position away from the center C2 of the power receiving coil 21. The control circuit 29 of the non-contact power receiving device 3 calculates the temperature difference G between the temperature T1 detected by the first temperature sensor 27 and the temperature T2 detected by the second temperature sensor 28, and calculates the gradient S indicating the change ratio of the temperature difference G. When the gradient S becomes equal to or greater than the preset first detection threshold value Th1, the control circuit 29 determines that the foreign object exists between the non-contact power transmitting device 2 and the non-contact power receiving device 3, and outputs the information for stopping the power transmission by the non-contact power transmitting device 2. The gradient S sharply changes compared to the temperature difference G and reaches the maximum value in a short time period. Therefore, the control circuit 29 can determine whether or not the foreign object exists more quickly than in the configuration in which the foreign object is detected in accordance with the temperature difference G.

### Second Embodiment

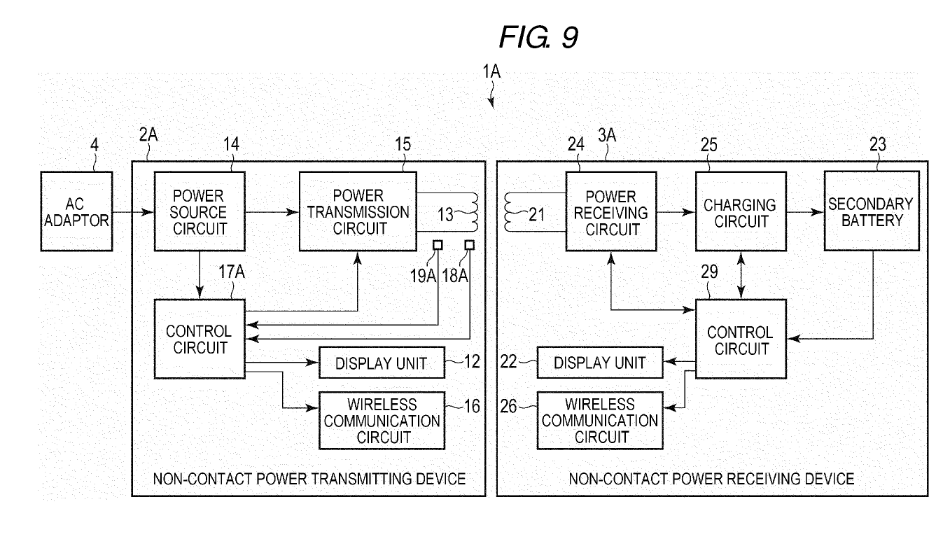

FIG. 9 is an explanatory view for describing a configuration example of a non-contact power transmitting device 2A and a non-contact power receiving device 3A of a non-contact electric power transmitting apparatus 1A according to a second embodiment. In addition, the second embodiment is different from the first embodiment in that the non-contact power transmitting device 2A performs the foreign object detecting instead of the non-contact power receiving device 3A.

The non-contact power transmitting device 2A includes the power source circuit 14, the power transmission circuit 15, the power transmission coil 13, the display unit 12, the wireless communication circuit 16, a first temperature sensor 18A, a second temperature sensor 19A, a control circuit 17A, and the like.

The first temperature sensor 18A and the second temperature sensor 19A are sensors for detecting the temperature, respectively. The first temperature sensor 18A and the second temperature sensor 19A respectively supply detection signals indicating the detected temperatures to the control circuit 17A.

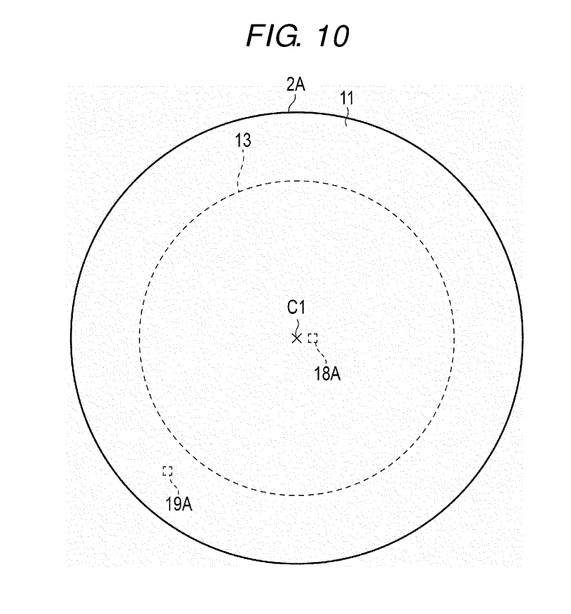

FIG. 10 is an explanatory view for describing an example of an installation position of the first temperature sensor 18A and the second temperature sensor 19A. As illustrated in FIG. 10, the first temperature sensor 18A detects the temperature in the vicinity of the center C1 of the power transmission coil 13. Further, the second temperature sensor 19A detects the temperature at a position away from the center C1 of the power transmission coil 13, for example, the temperature at a position further on the outside than the power transmission coil 13.

The control circuit 17A has the same configuration as the control circuit 17, and the operation at the time of the power transmission is different from that of the control circuit 17.

The non-contact power receiving device 3A includes the power receiving coil 21, the power receiving circuit 24, the charging circuit 25, the secondary battery 23, the display unit 22, the wireless communication circuit 26, and the control circuit 29. In other words, the embodiment is different from the first embodiment in that the non-contact power receiving device 3A does not include the first temperature sensor 27 and the second temperature sensor 28.

Next, the operation of the non-contact power transmitting device 2A having the above-described configuration will be described.

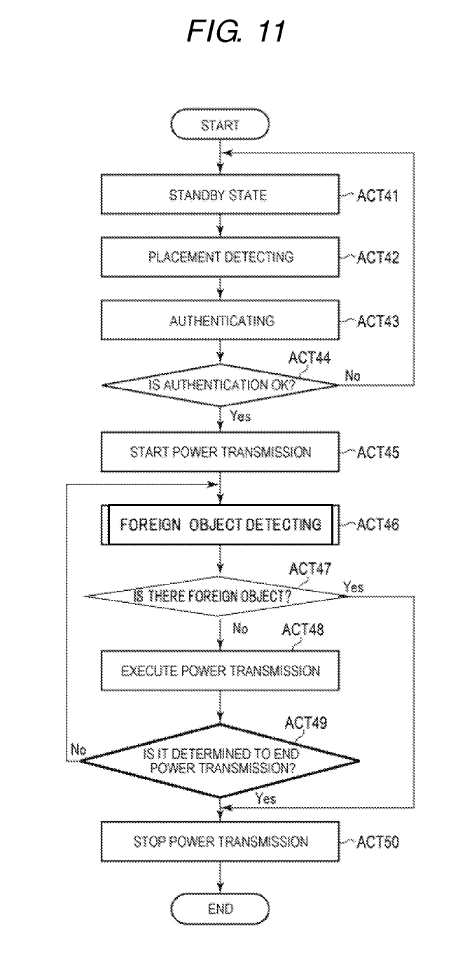

FIG. 11 is a flowchart for describing an example of the operation of the non-contact power transmitting device 2A. When being activated, the non-contact power transmitting device 2A operates in a standby state (ACT 41). At this time, the control circuit 17A controls such that the power transmission circuit 15 operates at regular time intervals. Accordingly, the power transmission circuit 15 intermittently supplies the transmission power to the power transmission coil 13.

The control circuit 17A performs the placement detecting while intermittently performing the power transmission (ACT 42).

When it is determined that the non-contact power receiving device 3A is placed on the power transmission table 11, the control circuit 17A performs the authenticating (ACT 43).

The control circuit 17A determines whether or not the result of the authenticating is normal (whether or not the authentication result is OK) (ACT 44). When it is determined that the authenticating is not performed normally (the authentication result is NG) (ACT 44, NO), the control circuit 17A moves to the process of ACT 41.

When it is determined that the authenticating is performed normally (ACT 44, YES), the control circuit 17A performs a control for supplying the transmission power from the power transmission circuit 15 to the power transmission coil 13 and starting the power transmission to the non-contact power receiving device 3A (ACT 45).

In addition, the control circuit 17A acquires each detected value from the first temperature sensor 18A and the second temperature sensor 19A, performs the foreign object detecting based on the acquired detected value (ACT 46), and determines the presence or absence of the foreign object (ACT 47). The foreign object detecting is a process for determining whether or not the foreign object, such as a metal, is inserted between the non-contact power receiving device 3A and the non-contact power transmitting device 2A. Foreign object detecting executed by the control circuit 17A in ACT 46 is the same process as the foreign object detecting executed by the control circuit 29 of the non-contact power receiving device 3 in the first embodiment.

When it is determined that there is no foreign object in the foreign object detecting (ACT 47, NO), the control circuit 17A executes the power transmission (ACT 48). In other words, the control circuit 17 performs a control so as to supply the transmission power to the power transmission coil 13 from the power transmission circuit 15, and continues the power transmission.

The control circuit 17A determines whether to stop the power transmission to the non-contact power receiving device 3A (ACT 49). For example, the control circuit 17A sequentially determines whether or not the non-contact power receiving device 3A has been removed from the power transmission table 11 during the power transmission, based on the value of the current supplied from the power transmission circuit 15 to the power transmission coil 13 or the value of the current supplied from the power source circuit 14 to the power transmission circuit 15. When it is determined that the non-contact power receiving device 3A has been removed from the power transmission table 11, the control circuit 17A performs the control so as to stop the power transmission. Further, the control circuit 17A may be configured to perform the control to stop the power transmission when receiving the information for instructing to stop the power transmission from the non-contact power receiving device 3A, due to, for example, full charge of the secondary battery 23.

When it is determined that the power transmission to the non-contact power receiving device 3A is not stopped (ACT 49, NO), the control circuit 17A moves to the process of ACT 46. In other words, the control circuit 17A continues the power transmission while repeatedly executing the foreign object detecting.

In addition, when it is determined to stop the power transmission to the non-contact power receiving device 3A (ACT 49, YES), the control circuit 17A stops the power transmission to the non-contact power receiving device 3A (ACT 50) and ends the process.

In addition, when the control circuit 17A determines that there is the foreign object in the ACT 47 (ACT 47, YES), the control circuit 17A moves to the process of the ACT 50, stops the power transmission, and ends the process. Thereafter, when the foreign object is removed and the non-contact power receiving device 3A is removed from the power transmission table 11, the control circuit 17A restarts the operation from the standby state (ACT 41).

As described above, the non-contact power transmitting device 2A may include the first temperature sensor 18A provided at the position close to the center C1 of the power transmission coil 13 and the second temperature sensor 19A provided at the position away from the center C1 of the power receiving coil 13, and may be configured to perform the foreign object detecting.

### Third Embodiment

The third embodiment is different from the other embodiments in that the non-contact power transmitting device 2A does not determine the presence or absence of the foreign object based on the comparison result between the gradient S of the temperature difference G in the first temperature sensor 18A and the second temperature sensor 19A and the preset first detection threshold value Th1, and determines the presence or absence of the foreign object based on the comparison result of between the temperature difference G and the variable second detection threshold value Th2. In addition, the non-contact power receiving device 3 in the first embodiment or the non-contact power transmitting device 2A in the second embodiment may execute the foreign object detecting. In the description of the embodiment, it is assumed that the non-contact power transmitting device 2A executes the foreign object detecting based on the comparison result between the temperature difference G and the variable second detection threshold value Th2.

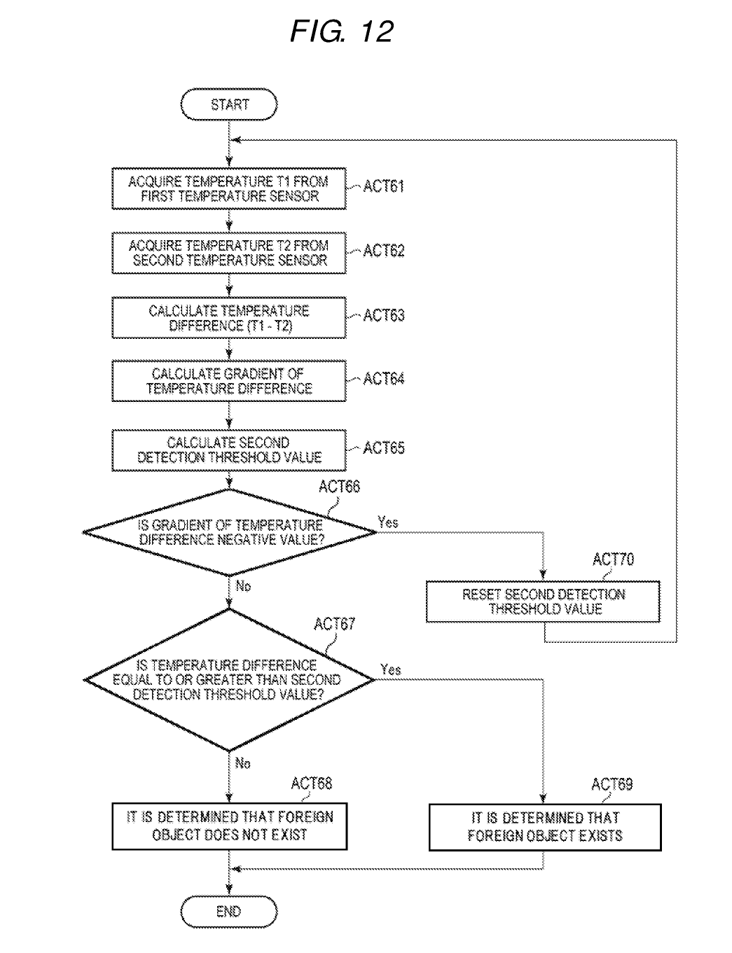

FIG. 12 is a flowchart for describing an example of the foreign object detecting in the non-contact power transmitting device 2A.

The control circuit 17A of the non-contact power transmitting device 2A acquires the temperature T1 from the first temperature sensor 18A (ACT 61). As described above, the first temperature sensor 18A supplies the detection signal indicating the temperature in the vicinity of the center C1 of the power receiving coil 13 to the control circuit 17A. By A/D converting the detection signal supplied from the first temperature sensor 18A, the control circuit 17A acquires the temperature T1 which is a value indicating the temperature.

The control circuit 17A of the non-contact power transmitting device 2A acquires the temperature T2 from the second temperature sensor 19A (ACT 62). As described above, the second temperature sensor 19A supplies the detection signal indicating the temperature at the position away from the center C1 of the power transmission coil 13 to the control circuit 17A. By A/D converting the detection signal supplied from the second temperature sensor 19A, the control circuit 17A acquires the temperature T2 which is a value indicating the temperature.

The control circuit 17A calculates the temperature difference G between the temperature T1 and the temperature T2 (ACT 63). The control circuit 17A calculates the temperature difference G by subtracting a lower value from a higher value at the temperature T1 and the temperature T2. In other words, the control circuit 17A calculates the absolute value of the temperature T1−the temperature T2 as the temperature difference G (G=|T1−T2|).

The control circuit 17A calculates the gradient S of the temperature difference based on the change of the temperature difference G according to the time (ACT 64). For example, the control circuit 17A stores the temperature difference G calculated every predetermined time in the memory. Based on the stored temperature difference G, the control circuit 17A calculates a change amount of the temperature difference G at predetermined time intervals as the gradient S of the temperature difference.

Further, the control circuit 17A calculates the second detection threshold value Th2 (ACT 65). The second detection threshold value Th2 is a value that changes according to the elapsed time from the start of the power transmission. Specifically, the control circuit 17A calculates the second detection threshold value Th2 by adding the value (increase estimated value) according to the elapsed time from the start of the power transmission to the preset initial value. The increase estimated value is a value that increases according to the elapsed time from the start of the power transmission. For example, the increase estimated value corresponds to the temperature difference G according to the elapsed time from the start of the power transmission when the foreign object does not exist. The initial value and the increase estimated value for calculating the second detection threshold value Th2 are stored in the memory of the control circuit 17A, for example.

In addition, the initial value and the increase estimated value for calculating the second detection threshold value Th2 may be stored for each type of the non-contact power receiving device 3A that receives the electric power. In this case, the control circuit 17A recognizes the type of the non-contact power receiving device 3A in the above-described authenticating, reads the initial value and the increase estimated value that correspond to the recognized type from the memory, and uses the values in calculation of the second detection threshold value Th2.

In addition, when the non-contact power transmitting device 2A is configured to be capable of transmitting a larger amount of power than that of the ordinary power transmission, the initial value and the increase estimated value for calculating the second detection threshold value Th2 for each amount to be transmitted may be stored. In this case, the control circuit 17A reads the initial value and the increase estimated value that corresponds to the amount to be transmitted from the memory, and uses the values in calculation of the second detection threshold value Th2.

The control circuit 17A determines whether or not the calculated gradient S of the temperature difference is a negative value (ACT 66). When it is determined that the gradient S of the calculated temperature difference is not a negative value (ACT 66, NO), the control circuit 17A determines whether or not the temperature difference G is equal to or greater than the second detection threshold value Th2 (ACT 67).

When the calculated temperature difference G is less than the second detection threshold value Th2 (ACT 67, NO), the control circuit 17A determines that the foreign object does not exist between the non-contact power transmitting device 2A and the non-contact power receiving device 3A (ACT 68) and ends the foreign object detecting. In this case, the control circuit 17A continues the charging. In addition, it is not indispensable to determine that the foreign object does not exist by the control circuit 17A, and the charging may be continued based on the determination result of the ACT 67.

In addition, when the calculated temperature difference G is equal to or greater than the second detection threshold value Th2 (ACT 67, YES), the control circuit 17A determines that the foreign object does not exist between the non-contact power transmitting device 2A and the non-contact power receiving device 3A (ACT 69) and ends the foreign object detecting. In this case, the control circuit 17A stops the power transmission to the non-contact power receiving device 3A. In addition, it is not indispensable to determine that the foreign object exists by the control circuit 17A, the charging may be stopped based on the determination result of ACT 67, and the power transmission to the non-contact power transmitting device 3A may be stopped.

In addition, when it is determined that the gradient S of the temperature difference is a negative value in ACT 66, the control circuit 17A resets the second detection threshold value Th2 (ACT 70) and moves to the process of ACT 61. For example, after switching from the power transmission state of supplying the electric power to the non-contact power receiving device 3A to the standby state of not supplying the electric power to the non-contact power receiving device 3A, the temperature difference G which has increased until now starts to decrease. In other words, although the temperature difference G is greater than the second detection threshold value Th2, a state where the power transmission is not performed is achieved. In the state, since the temperature difference G continues to decrease, it is not appropriate for the detection of the foreign object. Therefore, the control circuit 17A does not compare the temperature difference G with the second detection threshold value Th2 until the gradient S of the temperature difference reaches 0. In other words, the control circuit 17A calculates the gradient S indicating the change in the temperature difference G between the temperature T1 detected by the first temperature sensor 18A and the temperature T2 detected by the second temperature sensor 19A, and when the gradient S is a negative value, a state where it is not determined whether or not the foreign object exists and the power transmission is stopped is continued.

Next, a change in the temperature difference G when the foreign object detecting is performed as described above will be described.

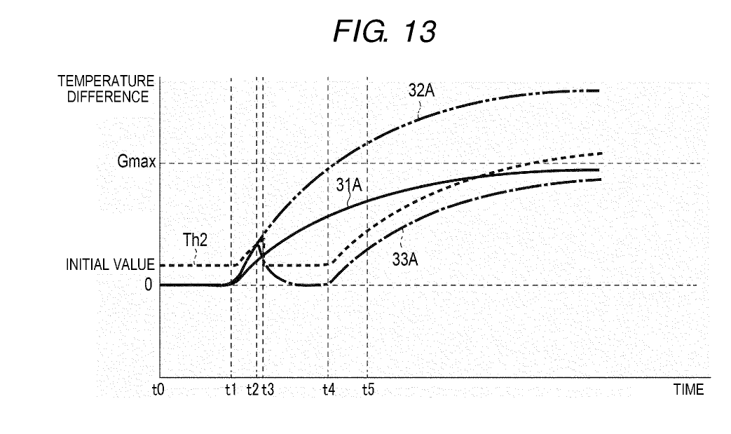

FIG. 13 is an explanatory view for describing the change in the temperature difference G after the charging is started. The vertical axis of FIG. 13 indicates the temperature difference G, and the horizontal axis indicates time.

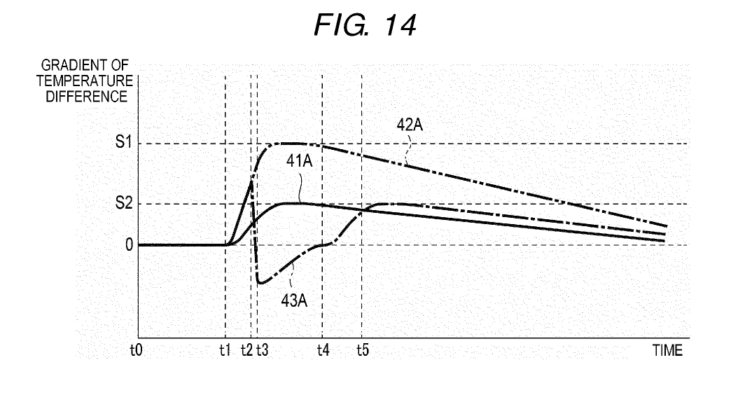

FIG. 14 is an explanatory view for describing the change in the gradient S after the charging is started. The vertical axis of FIG. 14 indicates the gradient S of the temperature difference, and the horizontal axis indicates time.

In addition, it is assumed that, at timing t0, the power transmission from the non-contact power transmitting device 2A to the non-contact power receiving device 3A is not started, and at timing t1, the power transmission from the non-contact power transmitting device 2A to the non-contact power receiving device 3A is started.

The second detection threshold value Th2 in FIG. 13 is a value obtained by adding the increase estimated value that corresponds to the elapsed time from the start of the power transmission to the initial value. The second detection threshold value Th2 starts to increase from timing t1 at which the power transmission is started. Further, the second detection threshold value Th2 is reset when the gradient S of the temperature difference G becomes a negative value and returns to the initial value. The second detection threshold value Th2 starts to increase again when the power transmission is started.

A first graph 31A in FIG. 13 is a graph illustrating a change in the temperature difference G when the foreign object does not exist. The first graph 31A illustrates that the temperature difference G is 0 between timing t0 and timing t1. Further, the first graph 31A illustrates that the temperature difference G is increasing after timing t1.

A first graph 41A in FIG. 14 is a graph illustrating a change in the gradient S of the temperature difference when the foreign object does not exist. The first graph 41A illustrates that the gradient S of the temperature difference is 0 between timing t0 and timing t1. Further, the first graph 41A illustrates that the gradient S of the temperature difference increases to the gradient S2 after timing t1, and thereafter, the gradient S of the temperature difference gradually decreases. In other words, the first graph 31A and the first graph 41A illustrate that, when the foreign object does not exist, the temperature difference increases from the timing when the power transmission is started, the temperature approaches saturation as time elapses, and the increase ratio of the temperature difference decreases.

A second graph 32A of FIG. 13 is a graph illustrating the change in the temperature difference G when the foreign object exists and the foreign object detecting is not performed. The second graph 32A illustrates that the temperature difference G is 0 between timing t0 and timing t1. Further, the second graph 32A illustrates that the temperature difference G is further increasing than that in the graph 31A after timing t1.

A second graph 42A of FIG. 14 is a graph illustrating the change in the gradient S of the temperature difference when the foreign object exists and the foreign object detecting is not performed. The second graph 42A illustrates that the gradient S of the temperature difference is 0 between timing t0 and timing t1. Further, the second graph 42A illustrates that the gradient S of the temperature difference increases to the gradient S1 after timing t1, and thereafter, the gradient S of the temperature difference gradually decreases.

The second graph 32A and the second graph 42A illustrate that, when the foreign object exists, the temperature difference sharply increases from the timing when the power transmission is started, the temperature approaches saturation as time elapses, and the increase ratio of the temperature difference decreases. In addition, the second graph 32A and the second graph 42A illustrates that the temperature difference G and the gradient S are greater than those when the foreign object does not exist.

A third graph 33A of FIG. 13 is a graph illustrating the change in the temperature difference G when the foreign object exists and the foreign object detecting is performed. The third graph 33A illustrates that the temperature difference G is 0 between timing t0 and timing t1. In addition, the third graph 33A illustrates that the temperature difference G increases from timing t1 to timing t2 and the temperature difference G becomes equal to or higher than the second detection threshold value Th2 at timing t2. In this case, the control circuit 17A determines that the foreign object exists and stops the power transmission. Therefore, as illustrated in the third graph 33A, the temperature difference G decreases from timing t2 when the power transmission is stopped to timing t4, and the temperature difference G increases again after timing t4 at which the power transmission is restarted.

A third graph 43A of FIG. 14 is a graph illustrating the change in the gradient S of the temperature difference when the foreign object exists and the foreign object detecting is performed. The third graph 43A illustrates that the gradient S of the temperature difference is 0 between timing t0 and timing t1. In addition, the third graph 43A illustrates that the gradient S of the temperature difference increases from timing t1 to timing t2 and the gradient S changes from a positive value to a negative value immediately after timing t2 at which the power transmission is stopped. In addition, the third graph 43A illustrates that the gradient S gradually returns to 0 thereafter from timing t3 to timing t4. The control circuit 17A does not perform the foreign object detecting immediately after timing t2 when the gradient S is negative until timing t4. Therefore, the power transmission is not restarted. When the gradient S returns to 0 at timing t4, the control circuit 17A performs the foreign object detecting again, and restarts the power transmission when the temperature difference G is less than the second detection threshold value Th2. In addition, the third graph 43A illustrates that the gradient S increases from timing t4 to timing t5, and the gradient S gradually decreases after timing t5.

The third graph 33A and the third graph 43A illustrate that, when the foreign object exists and the power transmission is stopped at the timing when the temperature difference G becomes equal to or greater than the second detection threshold value Th2, and when the temperature difference G has returned, the power transmission is restarted. Further, the third graph 33A and the third graph 43A illustrate that the foreign object is removed from the time when the power transmission is stopped until the power transmission is restarted, and the gradient S after the restart of the power transmission becomes gentle.

As described above, the non-contact power transmitting device 2A includes the first temperature sensor 18A provided at the position close to the center C1 of the power transmission coil 13 and the second temperature sensor 19A provided at the position away from the center C1 of the power receiving coil 21. The control circuit 17A of the non-contact power transmitting device 2A calculates the temperature difference G between the temperature T1 detected by the first temperature sensor 18A and the temperature T2 detected by the second temperature sensor 19A, and calculates the gradient S indicating the change ratio of the temperature difference G. Further, the control circuit 17A calculates the second detection threshold value Th2 that corresponds to the elapsed time after the power transmission is started. When the temperature difference G becomes equal to or greater than the second detection threshold value Th2, the control circuit 17A determines that the foreign object exists between the non-contact power transmitting device 2 and the non-contact power receiving device 3, and stops the power transmission.

When sufficient time has elapsed from the start of the power transmission, the temperature T1 detected by the first temperature sensor 18A and the temperature T2 detected by the second temperature sensor 19A are saturated. For example, when setting the threshold value to be compared with the temperature difference G to a fixed value, it is necessary to set a value Gmax higher than the saturated value of the temperature difference G when the foreign object does not exist as the threshold value. According to the example of FIG. 13, the timing at which the second graph 32A becomes equal to or greater than the second detection threshold value Th2 is timing t2, and the timing of exceeding the threshold value Gmax is timing t5. In this manner, the non-contact power transmitting device 2A can determine whether or not the foreign object exists earlier than a case where the threshold value compared with the temperature difference G is a fixed value.

In addition, in the non-contact power transmitting device 2A, a threshold value Th3 for comparison with the temperature T1 detected by the first temperature sensor 18A and the temperature T2 detected by the second temperature sensor 19A may further be set. The threshold value Th3 is a preset fixed value. For example, the control circuit 17A stores the threshold value Th3 in the memory. The control circuit 17A may be configured to compare the temperature T1 detected by the first temperature sensor 18A and the temperature T2 detected by the second temperature sensor 19A with the threshold value Th3, and to stop the power transmission when either one of the temperature T1 and the temperature T2 is equal to or higher than the threshold value Th3. Accordingly, the non-contact power transmitting device 2A can prevent the power transmission table 11 from generating heat when both the temperature T1 and the temperature T2 increase and the temperature difference G does not exceed the second detection threshold value Th2.

In addition, in the above-described embodiment, it is described that the control circuit 17A calculates the second detection threshold value Th2 that corresponds to the elapsed time from the start of the power transmission, and determines whether or not the foreign object exists based on the comparison result of the temperature difference G between the temperature T1 detected by the first temperature sensor 18A and the temperature T2 detected by the second temperature sensor 19A and the second detection threshold value Th2. The timing when the control circuit 17A calculates the second detection threshold value Th2 and the temperature difference G and determines whether or not the foreign object exists may be any timing as long as the second detection threshold value Th2 exceeds Gmax. For example, the control circuit 17A may be configured to calculate the second detection threshold value Th2 and the temperature difference G at the timing when a predetermined time period has elapsed from the start of the power transmission, and to determine whether or not the foreign object exists one time. In addition, for example, the control circuit 17A may be configured to calculate the second detection threshold value Th2 and the temperature difference G at a plurality of timings from the start of the power transmission, and to determine whether or not the foreign object exists.

In addition, in the above-described embodiment, it is described that the control circuit 17A resets the second detection threshold value Th2 when it is determined that the gradient S of the temperature difference is a negative value in the ACT 66 of FIG. 12, but the exemplary embodiment is not limited to the configuration. The control circuit 17A may be configured to reset the second detection threshold value Th2 when the gradient S of the temperature difference is less than an arbitrary value (−α) that is a negative value, and to move to ACT 61. With such a configuration, the control circuit 17A can determine again whether or not the temperature difference G is equal to or greater than the second detection threshold value before the gradient S of the temperature difference reaches 0. Accordingly, it is possible to shorten the time period until restarting the power transmission.

In addition, the heat generation due to the foreign object changes in distribution on the power transmission table 11 due to the position of the foreign object, the size of the foreign object, the material of the foreign object, and the like. Therefore, in the above-described configuration, when a region that generates heat over the detection positions of the plurality of temperature sensors exists, there is a possibility that the detection based on the temperature difference becomes difficult. Specifically, when the foreign object exists close to the second sensor 19A, there is a possibility that the temperature difference does not arise even though the existence of the foreign object. Here, the non-contact power transmitting device 2A may include more second temperature sensors 19A. When the non-contact power transmitting device 2A includes two or more second temperature sensors 19A, the control circuit 17A calculates the absolute value of the difference in a round-robin manner with 1:1 with respect to the temperatures detected by the first temperature sensor 18A and the plurality of second temperature sensors 19, and performs the foreign object detecting with the largest value as the above-described temperature difference G. Accordingly, for example, even when the second temperature sensor 19A exists in which the temperature difference from the first temperature sensor 18A is unlikely to arise because the foreign object exists close to the second temperature sensor 19A, the control circuit 17A can perform the foreign object detecting based on the temperature difference G between another second temperature sensor 19A far from the foreign object and the first temperature sensor 18A or the second temperature sensor 19A close to the foreign object. Accordingly, it is possible to prevent the accuracy of the foreign object detecting from deteriorating due to the position of the foreign object.

In addition, the example in which the non-contact power transmitting device 2A includes the plurality of second temperature sensors 19A has been described, but the non-contact power receiving device 3 may have a configuration including the plurality of second temperature sensors 28. In this case, the control circuit 29 calculates the absolute value of the difference in a round-robin manner with 1:1 with respect to the temperatures detected by the first temperature sensor 27 and the plurality of second temperature sensors 28, and performs the foreign object detecting with the largest value as the above-described temperature difference G. Accordingly, the control circuit 29 can perform the foreign object detecting based on the temperature difference G between the second temperature sensor 28 far from the foreign object and the first temperature sensor 27 or the second temperature sensor 28 close to the foreign object.

Further, it has been described that the second temperature sensor 28 is disposed at a position where the magnetic field received by the power receiving coil 21 is weak, but more ideally, it is desirable that the second temperature sensor 28 is disposed so as to be capable of detecting the temperature (ambient temperature) at a position that is not influenced by the temperature rise caused by the magnetic field. In this case, since the temperature detected by the second temperature sensor 28 does not change according to the position of the foreign object, the non-contact power receiving device 3 can perform the foreign object detecting with high accuracy by using one first temperature sensor 27 and one second temperature sensor 28. In addition, the same applies to the second temperature sensor 19A of the non-contact power transmitting device 2A.

In addition, when the non-contact power receiving device 3A to which the electric power is supplied by the non-contact power transmitting device 2A is large, there is a case where the power transmission coil 13 also becomes large.

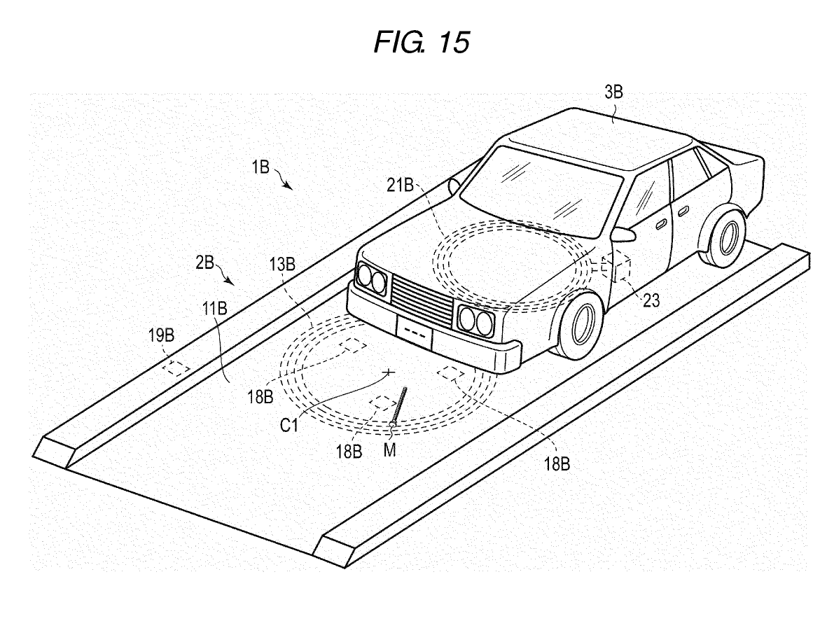

FIG. 15 is a view for describing a non-contact power transmitting device 2B and a non-contact power receiving device 3B which are another configuration examples of the non-contact power transmitting device 2A and the non-contact power receiving device 3A according to the second embodiment.

The non-contact power receiving device 3B is a device that is incorporated in a large-sized apparatus, such as an electric car, and receives the electric power from the non-contact power transmitting device 2B by using magnetic coupling, such as electromagnetic induction or magnetic field resonance.

The non-contact power receiving device 3B includes a power receiving coil 21B, the secondary battery 23, the power receiving circuit 24, the charging circuit 25, the wireless communication circuit 26, the control circuit 29, and the like. The power receiving coil 21B is an element that generates a current based on a change in the magnetic field, and is provided in a vehicle body (chassis) of the non-contact power receiving device 3B. The power receiving circuit 24 and the charging circuit 25 charge the secondary battery 23 with the power generated in the power receiving coil 21B.

The non-contact power transmitting device 2B is a device that supplies the electric power to the non-contact power receiving device 3B incorporated in a large-sized apparatus, such as an electric vehicle, by using magnetic field coupling, such as electromagnetic induction or magnetic field resonance.

The non-contact power transmitting device 2B includes a power transmission table 11B, a power transmission coil 13B, the power source circuit 14, the power transmission circuit 15, the wireless communication circuit 16, a control circuit 17B, a plurality of first temperature sensors 18B, a plurality of second temperature sensors 19B, and the like.

On the power transmission table 11B, a housing (chassis) of the non-contact power receiving device 3B is disposed.

The power transmission coil 13B is an element that generates the magnetic field by current. The power transmission coil 13B is disposed on the power transmission table 11B. When the non-contact power receiving device 3B is placed on the power transmission table 11B, the power transmission coil 13B is electromagnetically coupled to the power receiving coil 21B of the non-contact power receiving device 3B.

The control circuit 17B includes a processor and a memory. The control circuit 17B controls the operation of the non-contact power transmitting device 2B as the processor executes the program in the memory. By controlling the power transmission circuit 15, the control circuit 17B causes an alternating current to flow to the power transmission coil 13B connected to the power transmission circuit 15. Accordingly, the magnetic field generated in the power transmission coil 13B changes. Accordingly, the electric power is generated in the power receiving coil 21B electromagnetically coupled to the power transmission coil 13B. As a result, the electric power is supplied from the non-contact power transmitting device 2B to the non-contact power receiving device 3B.

The first temperature sensor 18B and the second temperature sensor 19B are sensors for detecting the temperature, respectively. The first temperature sensor 18B and the second temperature sensor 19B respectively supply detection signals indicating the detected temperatures to the control circuit 17B.

As illustrated in FIG. 15, the plurality of first temperature sensors 18B are provided on the inside of the power transmission coil 13B, that is, on the side closer to the center C1 than the power transmission coil 13B. In addition, the first temperature sensor 18B may not be provided on the inside of the power transmission coil 13B and may be provided between the power transmission coil 13B and the power transmission table 11B. In other words, the first temperature sensor 18B may be provided on the power transmission coil 13B. The first temperature sensor 18B may be provided at least on the side closer to the center C1 than the outer circumference of the power transmission coil 13B. The second temperature sensors 19B are provided on the outside of the power transmission coil 13B, that is, on the side further from the center C1 than the power transmission coil 13B.

As described above, when the non-contact power receiving device 3B and the non-contact power transmitting device 2B are large, the power transmission coil 13 of the non-contact power transmitting device 2B becomes large. In such a configuration, when there is only one first temperature sensor, there is a possibility that the influence of the temperature rise due to foreign object M does not reach the detection position of the first temperature sensor, and the foreign object M cannot be detected.

Here, the control circuit 17B calculates the absolute value of the difference in a round-robin manner with 1:1 with respect to the detection result of the plurality of first temperature sensors 17B and the detection result of the second temperature sensors 18B. Furthermore, the control circuit 17B performs the foreign object detecting with the largest value among the calculation results as the above-described temperature difference G. Accordingly, the control circuit 17B can perform the foreign object detecting based on the temperature difference G between the first temperature sensor 18B close to the foreign object M and the second temperature sensor 19B.

In addition, the function described in each of the above-described embodiments is not limited to the configuration using hardware, and can be realized by causing a computer to read a program that describes each function therein by using software. Further, each function may be configured by selecting either software or hardware as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-contact power receiving device which receives electric power wirelessly supplied from a non-contact power transmitting device, comprising:
a power receiving coil electromagnetically coupled to a power transmission coil of the non-contact power transmitting device;
a load circuit to which the electric power received by the power receiving coil is supplied;
a first temperature sensor for detecting a temperature of the power receiving coil;
a second temperature sensor for detecting a temperature at a position further away from the center of the power receiving coil compared to the first temperature sensor; and
a control circuit that calculates a gradient indicating a change in a temperature difference between the temperature detected by the first temperature sensor and the temperature detected by the second temperature sensor, and outputs information for stopping power transmission to the non-contact power transmitting device when the gradient is equal to or greater than a preset threshold value.

2. A non-contact power transmitting device which transmits electric power to a non-contact power receiving device, comprising:
a power transmission coil electromagnetically coupled to a power receiving coil of the non-contact power receiving device;
a power transmission circuit for transmitting the electric power by the power transmission coil;
a first temperature sensor for detecting a temperature of the power transmission coil;
a second temperature sensor for detecting a temperature at a position further away from the center of the power transmission coil compared to the first temperature sensor; and
a control circuit that calculates a gradient indicating a change in a temperature difference between the temperature detected by the first temperature sensor and the temperature detected by the second temperature sensor, and stops power transmission when the gradient is equal to or greater than a preset threshold value.

3. A non-contact power transmitting device which transmits electric power to a non-contact power receiving device, comprising:
a power transmission coil electromagnetically coupled to a power receiving coil of the non-contact power receiving device;
a power transmission circuit for transmitting the electric power by the power transmission coil;
a first temperature sensor for detecting a temperature of the power transmission coil;
a second temperature sensor for detecting a temperature at a position further away from the center of the power transmission coil compared to the first temperature sensor; and
a control circuit that compares a threshold value that increases according to elapsed time from a start of power transmission with a temperature difference between the temperature detected by the first temperature sensor and the temperature detected by the second temperature sensor, and stops the power transmission when the temperature difference is equal to or greater than the threshold value.

4. The device according to claim 3, wherein
the control circuit calculates a gradient indicating a change in the temperature difference between the temperature detected by the first temperature sensor and the temperature detected by the second temperature sensor, and continues a state where the power transmission is stopped when the gradient is a negative value.

5. A non-contact power receiving device which receives electric power wirelessly supplied from a non-contact power transmitting device, comprising:
a power receiving coil electromagnetically coupled to a power transmission coil of the non-contact power transmitting device;
a load circuit to which the electric power received by the power receiving coil is supplied;
a first temperature sensor for detecting a temperature of the power receiving coil;
a second temperature sensor for detecting a temperature at a position further away from the center of the power receiving coil compared to the first temperature sensor; and
a control circuit that compares a threshold value that increases according to elapsed time from a start of power transmission with a temperature difference between the temperature detected by the first temperature sensor and the temperature detected by the second temperature sensor, and outputs information for stopping the power transmission when the temperature difference is equal to or greater than the threshold value.
